(19) United States
(12) Patent Application Publication
(10) Pub. No.: US 2007/0130258 A1
(43) Pub. Date: Jun. 7, 2007

(54) WEB-BASED PUBLIC MESSAGING SYSTEM

(76) Inventor: John Almberg, Huntington Station, NY (US)

Correspondence Address: INTELLECTUAL PROPERTY LAW OFFICES, 1901 S. BASCOM AVENUE, SUITE 660, CAMPBELL, CA, 95008, US

(21) Appl. No.: 11/567,716

(22) Filed: Dec. 6, 2006

Related U.S. Application Data
(60) Provisional application No. 60/597,501, filed on Dec. 6, 2005.

(51) Int. Cl. G06F 15/16

(52) U.S. Cl. 709/204

(57) ABSTRACT

A system for users of web browsers a global communications network to communicate messages when visiting the same web sites. A client is installed with each browser and a server is provided remotely on the network. The client communicates its user's member and current web site information to the server. The server associates the users into sets at the respective web sites and informs each user's client who the other users are at the same web site. The client displays this to its user. Using their client, an author user inputs a new message that is communicated to the server, and the server communicates this new message to the clients of all users at the same web site as the author user. The clients then display each new message as received.

### CROSS-REFERENCE TO RELATED APPLICATIONS

This application claims the benefit of U.S. Provisional Application No. 60/597,501, filed 6 Dec. 2005, hereby incorporated by reference in its entirety.

### TECHNICAL FIELD

The present invention relates generally to electrical computers and digital processing systems, and more particularly to multicomputer transfer of user messages.

### BACKGROUND ART

Conventional web browsers today provide no facility for their users to communicate with other visitors to a web site. A web site visitor, using a web browser alone, cannot be aware of other visitors to a particular web site and therefore cannot communicate directly and in real time with such other visitors.

Some web sites presently provide utilities which enable visitors to communicate, but this communication is not direct and it is not real time. Typically, this visitor-to-visitor communication is provided by a mail list sponsored by the web site operator or via a bulletin board sponsored by the web site operator. Because this communication is neither direct nor real time, however, it is like leaving a written notice on an offline bulletin board, and returning later to see if another visitor has left a response pinned on the board next to yours. If a web site operator does not provide one of these communication utilities, then visitors to that web site can neither know about each other, nor communicate with each other. And if the web site operator does provide one of these communication utilities, then the utility is controlled and managed by the web site operator and it is thus possible for them to control, limit, monitor, filter, track, and record all visitor-to-visitor communication.

Conventional web browsers today also provide no facility for their users to communicate with the operators of a web site. A web site visitor, using a web browser alone, cannot be aware of the online presence of the operators of a particular web site and therefore cannot communicate directly and in real time with such online web site operators.

Some web sites presently do provide utilities which enable visitors to communicate with online operators of the web site. However, this visitor-to-operator communication is typically provided by a mail list sponsored by the web site operator, by a bulletin board sponsored by the web site operator, or by a live help application sponsored by the web site operator.

The end result of such a live help application is most similar to the invention about to be discussed. This type of application allows web site visitors to communicate directly and in real time with the operators of a web site, using typed messages. However, it suffers from several significant limitations. It only provides visitor-to-operator communication, not visitor-to-visitor communication. And it is not available on all web sites, because it is provided by software controlled and managed by the web site operator. Accordingly, it is not provided by the visitor's own native web browser and it is not functionally independent of the web site or web site operator. With respect to independence, without it all communication can be controlled, monitored, filtered, tracked, monitored, and recorded by the web site operator.

Traditional “chat” applications are widely used today, like AOL Instant Messenger (™).

However, such applications are Internet-based ones that have nothing to do with the other, ubiquitous Internet-based application called the World Wide Web.

Traditional chat applications merely allow users to connect to send and receive text messages to pre-designated users of the same application. That is, to people on their “buddy list” for the particular chat application. For this, neither user needs to be browsing the web, nor do they need to have a web browser open. Such traditional chat applications thus connect circles of friends and are circle-of-friends centered. Notably, they are not generally directed to or easily used for topic centered communication.

What has been sorely lacking is a web site centered chat system. One that connects users who are browsing the same web site, but with no “buddy lists” required or used. Preferably, all users who choose to be “visible” and “available for chatting” in such a system could then communicate with other visible and available users, as long as they are on the same web site.

### DISCLOSURE OF INVENTION

Accordingly, it is an object of the present invention to provide a public messaging (PM) system to permit World Wide Web (WWW) users, who use web browsers to visit web sites, to communicate directly and in real time with other visitors of those web sites and with the people who operate those web sites.

Briefly, one preferred embodiment of the present invention is a system for a plurality of users a global communications network who have web browsers to intercommunicate messages when collectively visiting same web sites. A messaging client application is provided at each web browser of each user, and a messaging server application is provided elsewhere in the network. The client communicate to the server member information identifying its user and site information identifying the web site its web browser is visiting. The server then associates the users with respective sets of list information based on the web site a user is determined to be visiting, and the server communicate to each user represented in a set a copy of that set. The client then displays a user list based on the set it receives. A client also accepts input of a new message from its user, as an author user, and communicates this message to the server. The server then communicates this new message to the clients of all users in the same set as the author user, and the clients display each such new message as received.

### BRIEF DESCRIPTION OF THE DRAWINGS

The purposes and advantages of the present invention will be apparent from the following detailed description in conjunction with the appended figures of drawings in which:

FIG. 1 is a block diagram depicting an exemplary embodiment of the inventive public messaging (PM) system in use, and showing how it can be implemented with PM clients, added onto otherwise conventional web browsers, and a PM server;

FIG. 2 is a browser screen representation showing how the inventive PM system will generally be perceived by its users;

FIG. 3 is a transaction chart showing user browsing in a typical embodiment of the PM system; and

FIG. 4 is a transaction chart showing the updating of user lists in a typical embodiment of the PM system.

In the various figures of the drawings, like references are used to denote like or similar elements or steps.

### BEST MODE FOR CARRYING OUT THE INVENTION

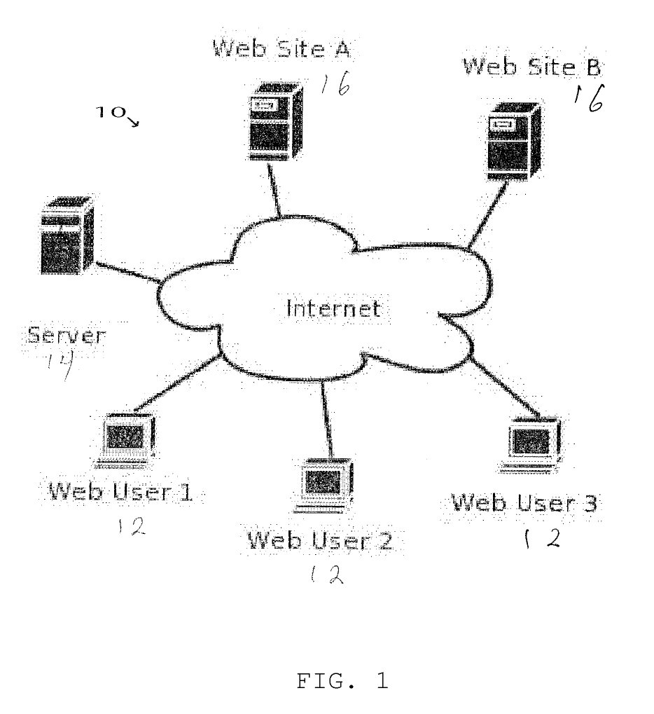

A preferred embodiment of the present invention is a public messaging (PM) system. As illustrated in the various drawings herein, and particularly in the view of FIG. 1, preferred embodiments of the invention are depicted by the general reference character 10.

The inventive PM system 10 enables World Wide Web (WWW) users, who use web browsers to visit web sites, to communicate directly and in real time with other visitors of those web sites, and with the people who operate those web sites. This communication can be in the form of: typed messages, voice, video, exchanged files, or any other direct, real time communication method.

Significantly, communication with the PM system 10 is functionally independent of the visited web sites and therefore is available to all users who use a suitably equipped web browser.

It thus may be available on all web sites, regardless of the software installed or not installed on those web sites. And it functions independently of web sites and their operators. It is therefore not inherently possible for the web sites or web site operators to control, limit, monitor, or filter, track, or record this communication.

FIG. 1 is a block diagram depicting an exemplary embodiment of the inventive PM system 10 in use, and showing how the PM system 10 can be implemented with PM clients 12, added onto otherwise conventional web browsers, and a PM server 14. Three users are represented here by PM clients 12 installed in their web browsers (Web Users 1, 2, 3). Two web sites 16 (Web Sites A, B) are active, and one PM server 14 has been provided. For the sake of this example, Web User 1 and Web User 2 are visiting Web Site A at the same time, while Web User 3 is visiting Web Site B also at that same time. All of the Web Users 1, 2, and 3 here have configured their PM clients 12 for Visibility =“Visible to other users” and for willingness to chat with other users =“Yes.” [N.b., the inventor has eliminated the idea of invisible users in present preferred embodiments because invisible ‘eaves-droppers’ do not fit with the goal of having a well-behaved society of users. Since this is an issue of philosophy rather than technology, however, the following discussion includes some coverage of actual technical capabilities that are in conflict with the philosophical goals for how it is hoped the present invention will serve us.]

In the PM system 10 just described, Web User 1 and Web User 2 can “see” each other by virtue of the PM functionality in their PM clients 12, and because they are both visiting the same web site (Web Site A) and their PM clients 12 are configured to permit this. They cannot, however, “see” Web User 3, because Web User 3 is visiting a different web site 16 (Web Site B).

For the same reason, Web User 3 cannot “see” Web User 1 or Web User 2. Either Web User 1 or Web User 2 can initiate communication with the other, via the functionality in their PM clients 12. But Web User 3 cannot initiate communication with Web User 1 or Web User 2, and neither can Web User 1 or Web User 2 initiate communication with Web User 3.

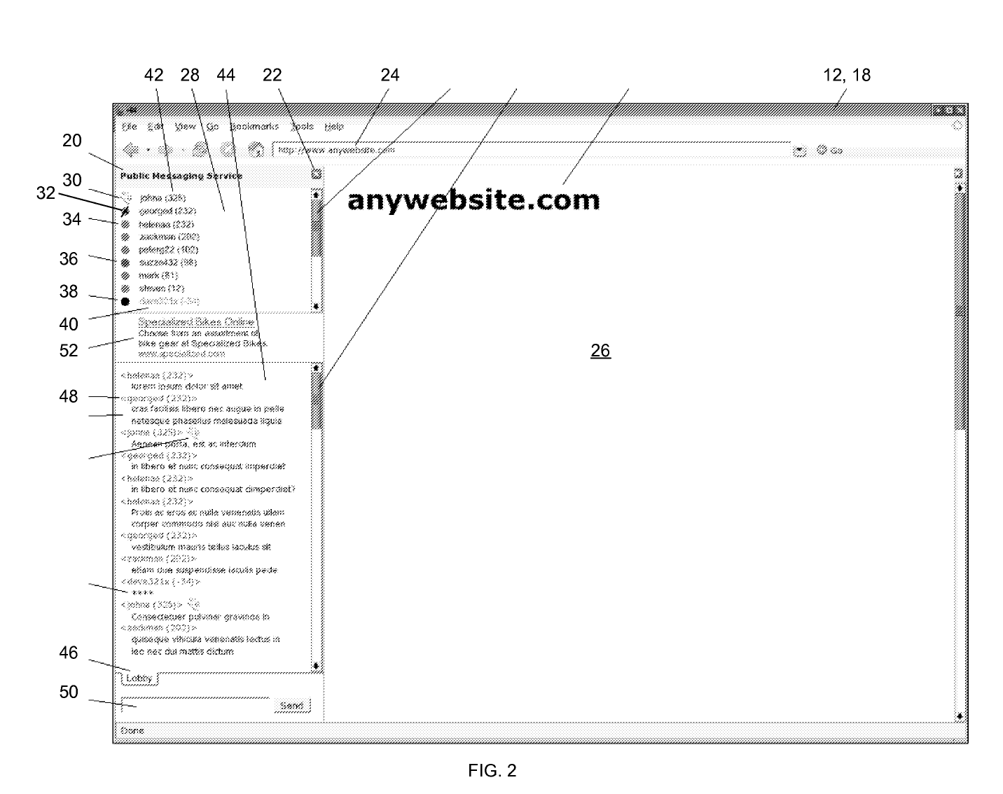

FIG. 2 is a browser screen representation showing how the inventive PM system 10 will generally be perceived by its users. The PM system 10 includes a PM client 12 that is installed in a web browser 18 (e.g., Internet Explorer (™) or Firefox (™)). It is anticipated that the PM client 12 will typically be installed and appear in the web browser 18 as a PM sidebar 20, although other user interface formats can also be used. The PM sidebar 20 can be hidden by clicking on a ‘close sidebar’ button 22. In generally conventional manner, a location for a typical web site 16 is specified by providing a URL in the browser address box 24, and the main pane 26 of the web browser 18 will then display the web page at this URL. In addition, however, the web location displayed by the PM client 12 is also controlled by this URL.

The PM client 12 can display a wealth of user information in a user list 28. For example, without limitation, authorized representative users 30 or guide users 32 can be identified by special icons, such as logos for the organizations they represent. Available normal users 34, i.e., ones who have set a ‘do not disturb’ status to “false,” can accordingly be identified with an icon that communicates this status. Conversely, non-available normal users 36, i.e., ones who have set their ‘do not disturb’ status to “true,” can be identified by a different icon that communicates this status. For various reasons it may also be desirable to have blocked normal users 38, i.e., ones who have a ‘blocked’ status set to “true,” say, by an authorized representative user 30. In addition to using special icons the users can be identified in the user list 28 by their user name 40 and a coolness quotient 42. Of course, considerable variation across possible embodiments of the PM system 10 is possible here. For instance, additional numeric quotients could also be provided or a one to five star ranking could be used, etc.

The PM client 12 can also display a wealth of messaging content in a message pane 44.

For simplicity, FIG. 2 depicts the message pane 44 including a single tab 46 labeled “Lobby,” but it is a simple matter to have multiple tabs here, say, one for the main dialog and others for sub-threads, filtered or searched message content, or private dialogs.

Within the message pane 44 the individual messages 48 can be depicted in various manners. The inventor's present preference is to provide a first line including the user name 40;

their coolness quotient 42; and, if they are an authorized representative user 30 or guide user 32, their special icon. In subsequent lines the content of the message 48 is displayed, except that asterisks or simply the text “Blocked”” will be displayed instead for blocked normal users 38.

For users to send new general messages a send control 50 is provided where text for a new message 48 can be typed and a send button can be clicked. Additionally, users of the PM system 10 can initiate a private dialog with one or more available users. This feature can also be implemented in a wide variety of ways, so one approach is described and the reader is urged to keep in mind that other approaches are encompassed by the spirit of the present invention.

A user can initiate a private dialog by double clicking the user name 40 of another user (or, in common Windows (™) practice, selecting users plural by keying hold-shift, click first, click last, release shift and double clicking the selected set; or by keying hold-ctrl, click those desired, release shift and double clicking the selected set). The thus selected user names 40 can then be represented with a color change (foreground, background, or both), underlining, etc. To remove a user name 40 from a private dialog or to end such a dialog, the user names 40 can simply be double clicked again, with confirmation from the PM client 12 by once again showing the user names 40 in the normal manner. The send control 50 can also employ this color change scheme, changing color to readily show the user that they are now engaged in a private rather than a public dialog. Of course, other schemes are also possible here, for instance, using a different pop-up type send control.

Wrapping up now with FIG. 2, this also illustrates some other features of the inventive PM system 10. The PM client 12 can have an alert space 52 available in the PM sidebar 20 for displaying advertisements and/or system alerts. If the user list 28 at a current web location grows to exceed the space available, it can become scrollable. Similarly, the message pane 44 can also become scrollable. These are, of course, conventional in many modem browser and web-based systems, but an important point o take from this is that many such conventional features can be incorporated into the inventive PM system 10 to extend its capabilities or to tailor particular embodiments for special applications.

Backtracking slightly now, since most of these have already been introduced by example above, The follow are major conceptual points which the inventor has reduced to formal definitions. The System is the total PM system 10, including server components and client components. The Server then is the PM server 14 part of the PM system 10. And the Clients are any PM client 12 which connects to the PM server 14. A PM client 12 always works in association with an open web browser 18. Typically, the PM client 12 is be installed as a sidebar in the web browser 18, however, it can also be implemented to undock from the web browser 18, and run it in it's own window. Even undocked, however, the PM client 12 always works in association with a web browser 18.

The Standard Client is the normal PM client 12, i.e., that installed and used by the normal users. Authorized Representative Clients (AR Clients) and Guide Clients are also contemplated.

These are essentially normal PM client 12 that are enhanced with additional capabilities to facilitate performance of the authorized representative and guide roles (described below).

A User is a person or software application that uses the PM system 10 to communicate with other users. Normal Users are people or software applications that have the default user access rights to the PM system 10. An Authorized Representative use is a person or software application that has special rights and powers at specific web sites 16, typically their or its own web site URLs, related to dealing with other users at such web locations. A Guide user is a person or software application that has special rights and powers on the PM system 10, related to guiding groups of users (examples are presented below). An Administrator is a person who has administrative rights to access and manage the PM system 10, i.e., a site administrator in sensationally the conventional sense, only here in the context of the PM system 10.

A Web Location is public messaging space which can be occupied by any number of the users. By default this is usually the hostname part of a web site's URL. At the option of the administrator, however, this space can instead correspond to a subdirectory of the hostname, or even multiple individual pages. On large sites or ones with many normal users visiting, the administrator can thus segment such a single space into several smaller spaces, based on the URL.

A normal or standard user is able to download a PM client 12 and install it in his or her browser. Since the PM client 12 is software, essentially any conventional or non-conventional delivery and installation mechanisms can be used for this.

Once a PM client 12 is thus procured and installed, in most anticipated embodiments of the PM system 10 a user will usually be able to use it to check to see if a new version is available, and to download and install it if desired. Optionally, this can be made a mandatory preliminary operation before general use of a PM client 12 is permitted, thus insuring that most users have current versioning.

Similarly, in most anticipated embodiments of the PM system 10 a user will be able to configure his or her PM client 12 to some extent. In particular, one such configuration option can be to automate checking for new versions and, at the user's option, to download and install any such new versions automatically.

Prior to any normal or standard usage, the PM client 12 (working with the PM server 14) should ensure that users are using a certified PM clients 12, rather than, for example, a special authorized representative client or a guide client. Optionally, integrity of the PM client 12 can be checked concurrently, for example, to ensure that it has not been altered by hacking, installation of spy-ware, or infection with a virus.

Also prior to any normal or standard usage, the PM client 12 (again working with the PM server 14) should ensure access is denied until the PM client 12 is certified (i.e., registered in the particular PM system 10 and any other initial formalities attendant with that having been completed).

In most anticipated embodiments the standard PM client 12 will also be able to play sound, sent by the PM server 14 or an authorized representative or guide client. One important anticipated use for this functionality is to assist or “guide” less sophisticated users in setting up their PM client 12 and becoming initially familiar with the PM system 10. Of course, initially and ongoing, this functionality can also be used for traditional trouble shooting purposes, say, to “talk” users through browser/server/client/other-application versioning or conflict issues.

Typically, a user's first formal interaction with an embodiment of the PM system 10 will be to register with it, by providing it with essentially convention registration information, e.g., a username, a password, and an email address. The PM system 10 can then request confirmation of a registration by sending the putative new user an email at the email address supplied during registration, and the user can confirm his or her registration by clicking on a link in this email. In general, it is anticipated that embodiments of the PM system 10 will verify that a user has such a “confirmed” registration before allowing the user to log into the PM system 10 with a PM client 12. As a practical matter of “miscreant control,” the PM system 10 can optionally also prevent a user from registering an abnormally large number of user accounts.

A user's next formal interaction with an embodiment of the PM system 10 will often be to access and edit a set of information that shall make up his or her profile. Of course, default profiles can be provided, that are tailored to the embodiments of the PM system 10 if desired, or a selection of standard profiles can be provided for selection or use as a starting point. In any case, many user can be expected to want to at least review their profile, and many can be also expected to want to configure it to optimize their interaction with and within the PM system 10.

A user profile will typically include fields like username (must be unique), password, and email address. It can optionally include fields for full name, a web address (e.g., for a MySpace (™) page), and one or more text fields for additional information, comments, etc.

In general, once entered, a user will not be able to edit his or her username. This is not a necessary limitation but, rather, is motivated out of the expected desire by administrators to simplify user record management. This permits all user account information to easily be tied to a user's username.

In many anticipated embodiments the users will be able to choose an icon from a set of pre-defined icons. Alternately, the users can be assigned icons based on any of various criteria.

For example, that authorize representative and guide users can have special icons has already been noted. Another possible icon assignment scheme is to use icon color to represent how long a user has been a member. For instance, red can be used for new users, orange and then yellow for longer term users, and ultimately green for longest term users. Yet another such scheme is to use icon shape to represent a user characteristic. For instance, musical notes can be used to represent the relative recent volume of messages that a user has been posting in a musical forum employing the PM system 10. An eight-note can denote minimal participation in the forum while a full-note denotes major participation. Of course, other “feedback” such as the ‘coolness quotient’ can help the other users evaluate how probative an icon is (i.e., some users may say a lot yet still say little that others value, or ‘a full-note may simply still be disharmonious in the current chord’).

A user will be able to edit his or her email address, but the new address will not replace the old one until it has been confirmed.

Once registered, a user is able to use his or her PM client 12 to log in and out of the PM system 10. Implicit in this is that a user is required to log into the PM system 10 to gain any access to it. This is not necessary, but is desirable and the inventor anticipates that it will be a requirement in most embodiments of the PM system 10.

An clear benefit to logging in is that the PM system 10 then can authenticate the user, to ensure that they are a confirmed, registered user, before granting further access. Coincidental with this, the PM system 10 can log all user log ins. Logged-in users can then be made ‘visible’ to other users at a same web site 16, and such users can use their PM client 12 to toggle a ‘do not disturb’ status to true or false (an initial state of true or false may be allowed as a permitted profile setting in some embodiments). If a user's ‘do not disturb’ status is “true” the PM system 10 can prevent other users from initiating private messaging to that user. As a matter of administrator choice, however, an authorized representative may still be permitted to initiate private messaging to such a user.

In general usage, the users employ the PM system 10 while browsing web sites 16 with their web browsers 18 that have been enabled by addition of PM client 12.

When a user visits a new URL, the web browser 18 notifies the PM client 12 of the new URL. The PM client 12 then requests the web location associated with the new URL and the PM server 14 returns an appropriate associated web location ID. If the web site 16 requested by the user has changed, the PM client 12 requests a list of users who are occupying the new web site 16 from the PM server 14 and updates its user list 28 to show these users. The PM client 12 next clears the message pane 44, and begins displaying messages 48 from the new web site 16. If desired, the PM system 10 can be implemented so that a user with more than one PM client 12 open can be able to occupy more than one web site 16 at a time. Optionally, the PM system 10 can log all of the web sites 16 browsed to by a user, with the log including a date/time stamp, user id, and URL.

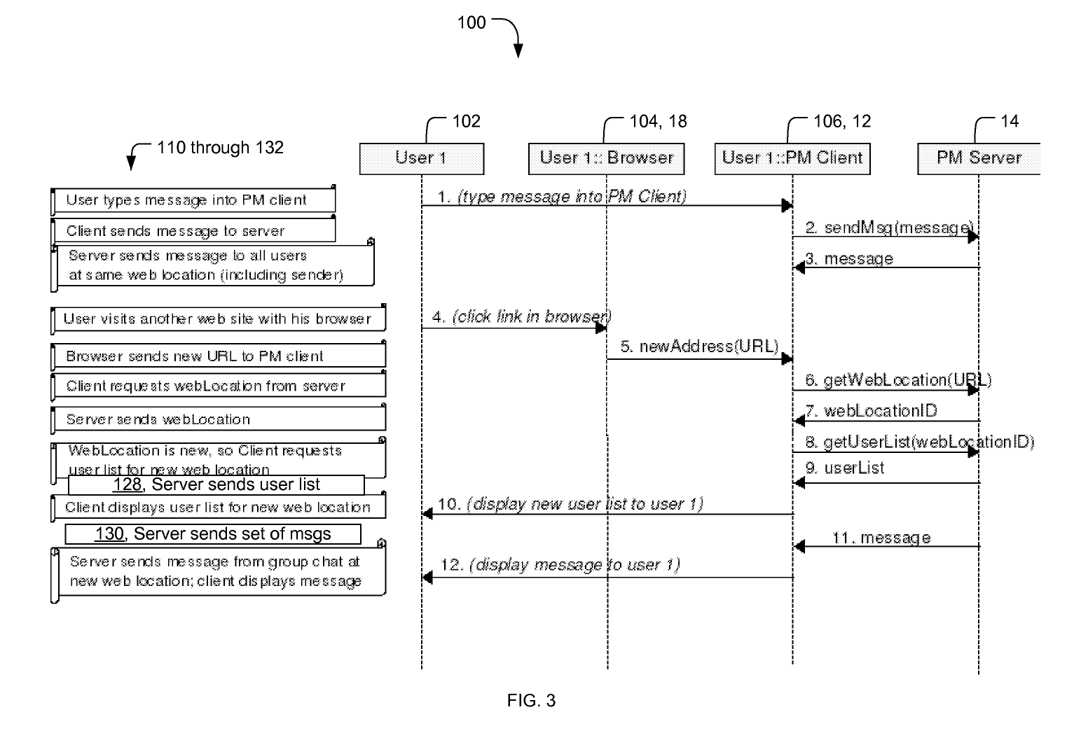

FIG. 3 is a transaction chart 100 showing user browsing in a typical embodiment of the PM system 10. Four entities are engaged in the transactions: a user 102 (User 1), the user's browser 104 (User 1::Browser, a web browser 18), the user's client 106 (User 1::PM client, a PM client 12), and a PM server 14. In a stage 110 (“1”) the user 102 types a message 48 into the send control 50 of their user's client 106. Next, in a stage 112, the user's client 106 sends the message 48 to the PM server 14. In a stage 114 the PM server 14 then sends the message 48 to the PM clients 12 of all of the users at the current web site 16 (including the user's client 106). In a stage 116 the user 102 now enters a new URL in the address box 24 of the user's browser 104 (e.g., clicks a link, types in the URL, etc.). Next, in stage 118, the user's browser 104 sends this new URL to the user's client 106 (or, so to speak, the user's client 106 obtains the new URL from the user's browser 104). In a stage 120 the user's client 106 then sends the new URL to the PM server 14. In stage 122 the PM server 14 sends the user's client 106 a webLocationID that the user's client 106 and the PM server 14 will then use to identify which particular web site 16 the user 102 is visiting to now potentially engaging in messaging at.

In the presently preferred embodiment of the PM system 10, stage 120 and stage 122 are essentially a request of the PM server 14 for the for a webLocationID, and a reply if it has such.

In principle a URL can be used to resolve which web site 16 is of interest, but in practice it is often desirable to instead use the webLocationID. It should be kept in mind here that the PM system 10 a web site 16 is not necessarily a traditional “web site” having a unique Internet protocol (IP) address. A conventional web server at one IP address may, for instance, host many forums that can each potentially be respective different web sites 16. And in any case resolving to an IP address and then through various in determinant levels of internal domain addresses can be odious and worth minimizing by use of webLocationIDs. The use of webLocationIDs also can help with logging, by reducing log volume and aiding readability.

Continuing, in stage 124 the user's client 106 determines whether the webLocationID received back from the PM server 14 in stage 122 is new and, if so, the user's client 106 requests current user information from the PM server 14 for the new web site 16 now being visited by the user 102. In stage 126, in straightforward manner, the PM server 14 sends this information to the user's client 106; in stage 128 the user's client 106 populates its user list 28 (i.e., displaying this information to the user 102); in stage 130 the PM server 14 sends a set of messages 48 (e.g., all messages in the last hour, day, etc., per an administrator set criteria); and in stage 132 the user's client 106 populates the message pane 44 (i.e., displaying these to the user 102 as well).

In the inventor's presently preferred embodiments, the PM clients 12 display in the user list 28 all of the currently logged-in users visiting a web site 16. That is, even non-available normal users 36 and blocked normal users 38 are displayed. This is a preference and not a requirement, however, and in alternate embodiments the display of such users can be suppressed or limited to only the authorized representative users 30.

The user list 28 preferably includes the following information for each listed user at a web site 16: an icon (varying depending on user profile setting, status, role as authorized representative or guide, etc.), user name 40, current coolness quotient 42, an ‘on buddy list’ indicator (if a user is on the current user's buddy list, an option described presently), and the user's status (‘do not disturb’ set to “true” or “blocked” set to “true” for any reason).

The entries in the user list 28 can be sorted in various orderings, with the inventor's preferred default being by the coolness quotient 42 (ranging from high positive to high negative).

The user of the PM client 12 can then initiate a re-sorting of the user list 28 (e.g., by time entering the web site 16, by user category such as buddy or role, etc.).

The PM client 12 can also permit an option of displaying a summary of the user list 28, rather than a complete listing of all of the users present at the web site 16. This option, in turn, can optionally permit expanding categories of users, such as Buddies, to include in the present view all of the present users in that category.

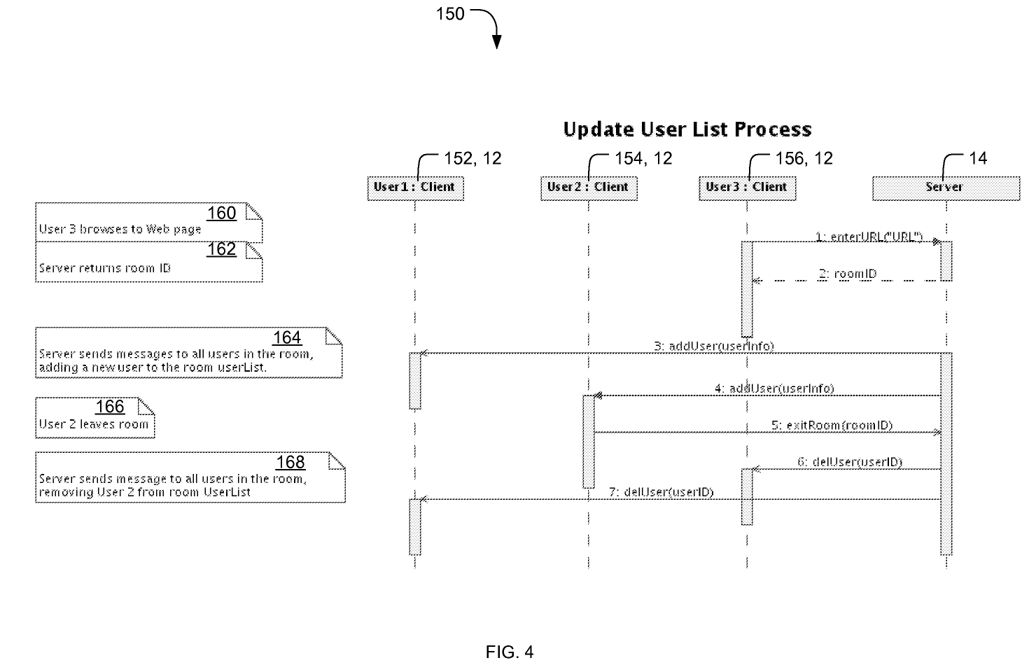

FIG. 4 is a transaction chart 150 showing the updating of user lists 28 in a typical embodiment of the PM system 10. Here four entities are present: a first user 152 (User 1, employing a PM client 12), a second user 154 (User 2, also employing a PM client 12), a third user 156 (User 3, also employing a PM client 12), and a PM server 14.

In a stage 160 the third user 156 here directs their web browser 18 to a different web site 16, thus providing the new URL for that web site 16 to the PM server 14 in the manner already discussed. In a stage 162 the PM server 14 returns the webLocationID (also sometimes referred to by the inventor as a “Room ID” for reasons that will become apparent as this example unfolds). In a stage 164 the PM server 14 sends information about the third user 156 to the other users (here, the first user 152 and the second user 154), and the PM clients 12 of these users update their user lists 28 accordingly. Then, in stage 166, the second user 154 ‘leaves the room’ (i.e., exits the current web site 16). [N.b., detecting this presents a minor technical challenge, but not one that a skilled programmer will find insurmountable. For instance, a simple keep-alive mechanism can be incorporated, whereby the PM server 14 periodically queries quite PM clients 12 and treats them as departed in the absence of any reply.] And finally in stage 168 the PM server 14 informs all of the remaining users in the room that the second user 154 has left, thus implicitly instructing the PM clients 12 of the other users to remove the second user 154 from their user lists 28.

Before wrapping up this general discussion of the user lists 28, one other aspect of the presently preferred embodiment of the PM client 12 merits mentioning again and now elaborating on. The entries in a user list 28 can be made clickable “links.” Left-clicking such a link (or the equivalent) can then retrieve (from the PM server 14) and locally bring up a pop-up window displaying the profile information of the thus selected user, and right-clicking such a link can pop up a menu to enable initiating a private chat.

The inventive PM system 10 can be implemented with a wide range of alert capabilities.

For example, when a user enters a web site 16, the PM clients 12 of all users already at that site can display an entry notice, such as “User Alpha has entered this web location.” Similarly, when a user leaves a web site 16, the PM clients 12 of all users at that site can display an exit notice, such as “User Alpha has exited this web location.” At a user's option, configurable in their PM client 12, the event of another user entering or leaving a web site 16 can also initiate playing an ‘entering location’ or ‘leaving location’ sound.

Users can also configure Special Alerts, for instance, to be notified when a specified user enters any or just a specified web location, and to be notified when specified keywords appear in any message pane 44 or just such at one or more specified web sites 16. These Special Alerts can be stored in the user's profile, and thus easily be available for the users to add, edit, and delete instances of them. The Special Alerts will only function for a user when they are logged in to the PM system 10, but they can be implemented to occur in response to events at one or more web sites 16 at which the user is not currently “present.” Automatically a PM client 12 can then be opened at that web site 16. Audible alerts can also be provided, regardless of whether the PM client 12 has the focus on the user's desktop.

All logged in users at a same web site 16 can participate in a single “group chat,” with the PM clients 12 of the users displaying the on-going messages 48 that constitute this as it progresses. The messages 48 include source identifying information, e.g., the user name 40 of the originating user, their coolness quotient 42, and a role or status icon, which is then followed by the text of the user's contribution (with the exception of the latter in submissions by blocked normal users 38).

Within the messages 48, the PM clients 12 can display well-formed URLs as clickable links and various utilitarian features can be provided. For example, the PM clients 12 can translate character-based emoticons included in the messages 48, such as :-), into icons. Or a user can configure his PM client 12 to suppress messages 48 from users whose coolness quotient 42 is below a certain threshold, from users who registered less than a given number of days ago, or from a list of specified users. The PM clients 12 can then either display such suppressed messages 48 with a special indicator, such as ‘Username: *****’ (default) or hide them entirely.

The users can log group chat sessions, i.e., dialogs or sets of the messages 48 and concurrent with this all of the present users can be displayed in such a log, even if their messages are being suppressed.

A user (requestor) can request a private chat with any other user (requestee) who is visiting a same web site 16. The PM clients 12 notify requestees when a requester has requested a private chat, with such notification optionally being accompanied by a ‘private chat request’ alert sound. The requestee then has the option of accepting or denying the private chat request. If the requestee accepts, the PM client 12 can create a new space to display the private chat (preferred) or replace the public version of the message pane 44 with a private one for messages 48 in the private chat, or split the existing message pane 44 into two sub-panes. [Considerable flexibility in design or configuration is possible here in the inventive PM system 10.] A user can then end a private chat at any time.

The PM system 10 can block all private chat requests to any non-available normal user 36 (optionally with an exception being when the requester is an authorized representative user 30), and it can block private chat requests from blocked normal users 38. Users can also configure their PM clients 12 to block all private chat requests from any user whose coolness quotient 42 falls below a specified threshold, from users who registered less than a given number of days ago, or from a list of specified users. Additionally, the PM system 10 can prevent users (gadflies) from requesting abnormally large numbers of private chats.

In the discussion above elaboration about the coolness quotient 42 has been deferred until now. In general, in many applications of the PM system 10 a ranking feature like this can be provided. Obviously, for instance, in the context of technical subject matters, “coolness” may not be as appropriate a descriptive term as “knowledgeableness” or “reliability,” but the underlying principle still obtains. All users the PM system 10 can be assigned or can earn a ranking, reflected in their coolness quotient 42 or some equivalent that becomes a part (that is not personably editable) of his or her profile and that may be overtly display next to their user name 40 in user lists 28.

In the inventor's presently preferred embodiments of the PM system 10 the user lists 28 are by default sorted according to the coolness quotients 42, from high to low. The users should not be allowed to rank themselves, or otherwise influence their own coolness quotient 42 in any way, other than by their perceived coolness (or not) before the other users. Only users with positive coolness quotients 42 can be allowed to rank other users as ‘cool’ or ‘uncool,’ but then only once (or once per given time period, say, once every three months), or both cool and less cool users can be allowed to rank others. Rankings received from users with a high coolness quotients 42 can carry more weight than rankings received from users with low coolness quotients 42. If a user receives a ‘cool’ ranking, their coolness quotient 42 goes up, and, if they receive an ‘uncool’ ranking, their coolness quotient 42 goes down. A single ranking can have a small effect, thus not too easily permitting accumulating a high or low coolness quotient 42. The effects of the rankings, however, can be cumulative, so that many positive rankings can protect a user's coolness from a few negative rankings. To insure fairness, the PM system 10 can also detect users who issue abnormally large amounts of coolness quotient 42 input, with deletions of rankings from such users or lowering even their coolness quotient 42 then being merited out as punishment for abuse.

Buddy lists are another optional feature of the inventive PM system 10 that has been mentioned in passing but not yet elaborated on. Like some existing messaging systems used in other contexts today, it is desirable that a user (requestor) be able to request ‘buddy’ status from another user (requestee). To achieve that in the context of the PM system 10, the PM clients 12 can accept requests for buddy status from requester and display them requestees. If a requestee accepts such a request, then the PM system 10 can create a buddy relationship between the two users.

After this, a PM client 12 can display its user's buddies in the user list 28 in a distinctive way. When a user enters a web site 16, the PM clients 12 of the user's buddies should—at those user's option set in their respective PM clients 12—play a ‘buddy entrance’ sound. Similarly, when a user leaves a web site 16, the PM clients 12 of that user's buddies should—optionally—play a ‘buddy exit’ sound. The user can terminate any of their buddy relationships at any time, and the user can suppress buddy requests from a list of specified users. The PM system 10 can also suppress buddy requests from all blocked normal users 38.

The ability to have guide users 32 is an advantage which the inventive PM system 10 uniquely enables in web browsing. The guide users 32 can conduct groups on tours of web sites 16, interacting significantly and specifically with the users. When a guide user 32 moves to a new web site 16 or to a new location from a web site 16 (e.g., a sub-page), all members of his or her group can then follow to the same location.

Obtaining the of status of a guide user 32 can be permitted in various ways. In some cases, the users can use their own PM client 12 to set their status (e.g., change a setting to “True” or “False”). Optionally, the PM system 10 here can include a limiting mechanism, say, administrator review and possible override. In other cases, an authorized representative user 30 can appoint one or more guide users 32, by setting status settings that these users cannot directly set for themselves. As already noted in passing, the general users of the PM system 10 will see in a special guide icon or other suitable indication in their user lists 28 to reflect which users have guide status at a current web site 16.

The guide users 32 can particularly form groups, granting or denying inclusion in a group they form to any user at the web site where the guide user 32 is a guide (yet at other web sites 16, the guide user is potentially merely just another normal user). In general, the inventor expects that a guide user 32 will be limited to forming only one group at a time and that the normal or standard users will then request inclusion in the group (albeit, perhaps at he urging or enticement of other users, from the guide user 32, or from an authorized representative user 30). To assist in group formation a guide user 32 can also signal logged in members of his or her buddy list, either individually or as collectively, that he or she is forming a group at a specified web site 16, at a specified time, for a specified reason. A guide user 32 can kick out any user from his or her group at any time, and users can elect to leave the group at any time.

Once thus formed, a group can engage in group browsing or touring. When a guide user 32 moves to a new web site 16, the group automatically moves as well to the same location. And as the group experience progresses, the guide user 32 can chat informatively, responsively, and interrogatively with the grouped users in private. [N.b., automating the movement by the group collectively is another minor technical challenge that should be well within the capabilities skilled programmers. In present embodiments of the PM system 10, a change in the URL being visited by the guide user 32 is detected by their guide client (a specially enhanced PM client or a general PM client 12 having an enhanced guided-features set enabled). The guide client then communicates the new URL to the PM clients 12 of the group members, and these PM clients 12 then enter the new URL into the address boxes 24 of the web browsers 18 of the group members.]

Optionally, envisioned primarily for large or complex web sites 16 (e.g., a www.MegaSearchSite.com, a www.MegaVendorSite.com, a www.UniversityOfferingsSite.edu, a www.OrganizationStandardsSite.org, a www.CountrySite.gov, etc.), authorized guides can be provided. In general, authorized guides are conceptually an extension of the guide user 32, except that ad hoc self-appointment to this status should probably not be allowed. Rather, the authorized guide user can be sub-class or offshoot of the authorizer representative user role, or the authorized guide user can be one granted this status by an administrator or an authorizer representative user.

And, wrapping up now, only the authorized representative users 30 have not been discussed in detail. The purpose of the authorized representative user 30 is to allow the owners or employees of a web site 16 to present themselves as “Authorized” at that site, and thus to facilitate the delivery of service to the other users. In principle, any registered users can request an upgrade of their registration at a specific web site 16, making them authorized representative user 30 at that site. In practice, however, an administrator should have to grant such an upgrade and the thus privileges and powers that this entails. These include: having the AR status/role icon rather than the normal user icon displayed at the subject web site 16; conducting any number of private chats; having an infinitely high coolness quotient 32, access to and the right to use a special AR client and server applications, and other perks and remunerations commensurate with their contribution to the enterprise.

While various embodiments have been described above, it should be understood that they have been presented by way of example only, and that the breadth and scope of the invention should not be limited by any of the above described exemplary embodiments, but should instead be defined only in accordance with the following claims and their equivalents.

What is claimed is:

1. A system for a plurality of users a global communications network who have web browsers to intercommunicate messages when collectively visiting same web sites, the system comprising:
in said web browser of each said user, a messaging client application;
in said network remote from said users and from said same web sites, a messaging server application;
said messaging client application to communicate to said messaging server application:
member information identifying its said user, and
site information identifying the said web site its said web browser is visiting;
said messaging server application to:
associate said users with respective sets of list information based on the said web site a said user is determined to be visiting, and
communicate to each said user represented in a said set of list information a copy of that said set of list information;
said messaging client application to display a user list based on a received said set of list information;
said messaging client application to accept input of a new said message from its said user, as an author user, and to communicate said new said message to said messaging server application;
said messaging server application to communicate said new said message to the said messaging client applications of all said users in the same said set of list information as said author user; and
said messaging client application to display each said new said message as received.
